(19) United States
(12) Patent Application Publication
(10) Pub. No.: US 2008/0206037 A1
(43) Pub. Date: Aug. 28, 2008

(54) Pallet Loading and Uploading Apparatus

(76) Inventor: Peter James Radbourne, Basingstoke (GB)

Correspondence Address: MILLS & ONELLO LLP, ELEVEN BEACON STREET, SUITE 605, BOSTON, MA, 02108, US

(21) Appl. No.: 11/917,056

(22) PCT Filed: Jun. 7, 2006
(86) PCT No.: PCT/GB06/02089

§ 371 Date: Jan. 31, 2008

(30) Foreign Application Priority Data
Jun. 10, 2005 (GB) 0511896.3

(51) Int. Cl. B65G 57/06

(52) U.S. Cl. 414/792.1

(57) ABSTRACT

The apparatus comprises a platform (10) to receive a load (12) to be loaded onto a pallet (14), a pallet shelf (16) for supporting a pallet (14) below the platform (10), means for retracting the platform (10) from an extended position to a retracted position, and an abutment surface (20) for abutting the load (12) loaded on the platform (10) as the platform (10) is retracted, whereby the load (12) is allowed to drop onto a pallet (16) supported on the pallet shelf (16). The platform (10) is in the form of a sliding shutter and retraction of the platform (10) follows a non-linear path (22). The platform (10) comprises an upper support surface (66) having a plurality of apertures (68) therethrough. Freely rotatable members (70a, 70b) are mounted in the apertures (68) each having a surface of rotation which intersects the plane of the support surface (66). Selected ones (70a) of the rotatable members (70a, 70b) are rotatable at least about a horizontal axis extending in an first direction (72) while selected others (70b) of the rotatable members (70a, 70b) are rotatable at least about a horizontal axis extending in a second direction (74). The position of the load (12) supported on the platform (10) may be thereby adjusted in any horizontal direction.

### FIELD OF THE INVENTION

The present invention relates to a pallet loading and uploading apparatus, particularly for the automatic or semi-automatic loading or unloading of pallets.

### BACKGROUND OF THE INVENTION

A pallet loading apparatus is used to load a load onto a pallet for onward transportation. The load may comprise several (e.g. 10 to 12) layers or tiers which need to be loaded onto the pallet in turn. Each tier may be, for example, the output of an article processing apparatus such as a stack of paper sheets from a guillotine.

Generally the load will exit the processing apparatus at an elevated position, whereas for onward transportation it is preferred that the pallet should be at floor level. The load may well be of a size and weight as to render the manual manipulation thereof difficult or slow.

In a known pallet loading apparatus the load to be loaded onto a pallet is slid into position over a retractable platform. A pallet is placed beside a loading shelf on the floor. Once the load for that tier is in position, a back gauge which was used to align the work lifts up. The loading platform moves under this gauge and positions itself over the pallet. Depending upon the height of any existing load on the pallet, the platform either lifts or lowers to be just above the level of the existing pre-loaded work. Once the platform is over the platform the aligning back gauge lowers behind the tier. The aligning back gauge now becomes the stop that pushes the load of the platform onto the pallet or previous tier as the platform returns to its loading position.

Such an apparatus occupies considerable space. The loads are loaded onto the platform from one side and the loaded pallet is removed from the front, so that the platform has to be retracted backwards. To allow sufficient space for the retracted platform, the guillotine, or other article processing apparatus, cannot be located closely adjacent a wall of the working area. At best this means the loss of valuable working area space, and at worst it means that such a pallet loading apparatus cannot be used at all. Also, because of the design and weight it prohibits the apparatus from being relocated as it has to be bolted to the floor to stop it falling over.

We are aware of U.S. Pat. No. 3,941,048 (Oe et al.) which describes an apparatus for loading goods on a pallet. The apparatus comprises a frame, a packed commodity dropping opening formed in said frame, a number of carriage rollers mounted for movement on said packed commodity dropping opening between the front and rear edges of said opening to close and open the opening, a fixed stopper disposed forwardly of said packed commodity dropping opening, a movable stopper disposed rearwardly of said packed commodity dropping opening, an elevational platform elevationally mounted beneath said packed commodity dropping opening and adapted to move upwardly and downwardly while supporting a pallet thereon, and a presser mounted above said packed commodity dropping opening and supported for vertical movement by a cylinder to press against bags holding commodities therein and supported by said carriage rollers.

German patent specification DE 3522982 (Bischof) which relates to a pallet loader, in which the loading surface for the incoming material is formed from individual plates which are fastened by their ends to roller chains which are driven by chain wheels and extend parallel to one another. Because of their unfavourable roller chain guiding system, known pallet loaders require a space which is several times as large as the surface to be palletised. Other pallet loaders require two loading tables. In these designs, the loaded pallets are not close to the ground and a forklift truck is required for removal. The solution is to provide a chain guiding system in which the roller chains are guided and tensioned in the shape of an “L” rotated through 180 degrees, i.e. the guideway for reciprocation of the plate loading table in relation to the material to be palletised on the pallet close to the ground approximately describes an open right angle. The inlet for the material to be palletised is vertically adjustable and can receive the material to be palletised from any height. The pallet is raised and lowered for loading by means of a spindle. An intermediate layer inserting device with a magazine is mounted above the plate loading table.

French patent specification FR 2573401 (Lycee Technique) describes a method and installation for stacking superimposed horizontal layers of objects on a pallet. According to this method, a flexible belt is spread over the last layer of objects already stacked, a new layer of objects is placed on the belt, the latter is withdrawn in such a way that the objects of the new layer are deposited by gravity on those of the last layer, the pallet is lowered by a height corresponding to that layer, the belt is spread again, and the operation is repeated until the desired number of layers is obtained. Rapid stacking of objects on a pallet.

German patent specification DE 3027993 discloses a pallet loading unit which consists of a lifting device fixed on two stands, a pallet conveyor installation with loading area and with a piece goods collecting point with layer readying station. The lifting device is fitted with a loading platform capable of being moved to and fro in a horizontal plate, which receives the piece goods either separately or in layers and transfers them on to a pallet by a withdrawal movement. The loading platform is formed as a support platform which can be rolled in and is stable on one side, which can be rolled in after transferring a layer of piece goods within the area of the stands and which can be rolled out again after being lowered into the receiving plane below the piece goods layer.

European patent specification EP 0195241 (Kolbus) discloses an apparatus for loading individual articles onto pallets, with a platform which carries individual articles and which can be withdrawn from beneath them in order to effect transfer to a stacking station, and with a restraining means for holding the said articles securely while the platform is being withdrawn, this platform being formed by a group of load-carrying bars, fastened to driven chains which are led around direction-changing wheels characterized in that the load-carrying bars are designed as profile-section bars which interengage positively in the horizontal plane.

German patent specification DE 4424287 (KBA-PLANETA) discloses an auxiliary stacking device for paper sheets, in which the carrier elements are formed as roller members which by non-positive locking form an extended path. The roller members consists of inner links and outer links located one behind the other and supported by pivot bolts. A tensioning cable engages with the outer link and connects the inner link as well as the pivot bolts. The tensioning cable is guided through aligned longitudinal bores passing through the inner links and the pivot bolts.

The present invention seeks to overcome these disadvantages.

### SUMMARY OF THE INVENTION

We have discovered that the aforesaid disadvantages can be overcome wherein the platform is in the form of a sliding shutter and retraction of the platform follows a non-linear path, and the platform is constructed in a particularly advantageous manner.

Thus, according to a first aspect of the invention, there is provided a pallet loading and uploading apparatus comprising:
(i) a loading and unloading platform to receive a load to be loaded onto a pallet;
(ii) a pallet shelf for supporting a pallet below the platform;
(iii) means for retracting the platform from an extended position to a retracted position; and
(iv) an abutment surface for abutting the load loaded on the platform as the platform is retracted, whereby the load is allowed to drop onto a pallet supported on the pallet shelf;
   wherein the platform is in the form of a sliding shutter and retraction of the platform follows a non-linear path. The apparatus is characterised in that the platform comprises an upper support surface having a plurality of apertures therethrough, freely rotatable members mounted in the apertures each having a surface of rotation which intersects the plane of the support surface, selected ones of the rotatable members being rotatable at least about a horizontal axis extending in an first direction and selected others of the rotatable members being rotatable at least about a horizontal axis extending in a second direction, whereby the position of the load supported on the platform may be adjusted in any horizontal direction.

In a preferred embodiment, the return of the platform to its extended position follows the same non-linear path.

The sliding shutter is preferably a slatted shutter, that is a plurality of articulated slats constrained to move together along a non-linear path, of such construction as is used in, for example, roll-top desks and the like.

In a preferred embodiment, the platform is supported by a housing, preferably an open-top housing, including a back wall and side walls, the platform being retractable into the back wall. The apparatus may further comprise means for raising and lowering a pallet supported on the pallet shelf between an upper position in which a load can be dropped onto the pallet from the platform and a lower position where the pallet, with the load loaded thereon, can be removed from the apparatus. Also, the apparatus may further comprise a control device adapted to cause the following steps:
(i) to retract the platform when the load has been received thereon, whereby the load is allowed to drop onto a pallet supported on the pallet shelf;
(ii) to lower the pallet from the upper position to the lower position;
(iii) to raise a replacement pallet from the lower position to the upper position; and
(iv) to return the platform to its extended position before a further load are received thereon.

Usually, the upper position of the pallet will be just below the platform, such as from 10 mm to 20 mm below, so that the drop of the load is as small as possible, to minimise any possible damage or spillage. The lower position of the pallet is preferably at least low enough that when the platform returns to its extended position, it will not foul the top of the load on the pallet.

In a possible embodiment of the invention, the apparatus is capable of loading a plurality of tiers of articles, one on top of another. To achieve this, the pallet can be lowered to a number of progressively lower positions, at each of which the top of the uppermost tier on the pallet will be just below the platform. The lowermost position for the pallet will ideally be at floor level, from where the loaded pallet can be conveniently removed by a pallet truck or fork truck.

After a loaded pallet has been removed, a new pallet can be positioned on the pallet shelf for the process to be repeated.

One or more safety devices may be provided to protect the operator and apparatus from injury or damage:
(i) to ensure that the pallet is not raised to its upper position unless the platform is completely retracted; and/or
(ii) to ensure that the platform is not returned to its extended position if the load height is above the path of the platform; and/or
(iii) to ensure that the pallet shelf is not lowered to below a predetermined height, say 170 mm, above the floor in the event of an obstruction below the pallet shelf to comply with current EN regulations.

These safety devices may be in the form of light barriers and magic eyes. For example, two light beams may be directed from corner to corner above the pallet shelf to determine the height of the load or pallet under the platform, so that no matter how small the load it will always be detected by at least one beam. The platform may be provided with a light beam directed across its leading edge so that when it moves forward ready for a new load, no work is pushed off the pallet. If it detects anything whilst moving forward the platform stops and the pallet shelf lowers. If the pallet shelf lowers by more than a predetermined amount set by the operator, a warning device, such as a bleeper and/or flashing warning lights, is activated to alert the operator. The reason for this is so that the load has only a short way to drop from the platform to prevent spillage.

Manually operable means may be provided to override one or more of the safety devices.

The abutment surface may be provided by a back stop member. The position of the back stop member may be adjustable to determine the position of the load on the pallet. The back stop member may be pushed back flush to the back wall because it may protrude from the back of the machine and could cause a trap area for the rising load if the machine was being used for uploading work.

The platform may be provided with side stop members to limit movement of the load in a direction towards one edge of the platform and to determine the position of the load on the pallet. Preferably such side stop members are movable from one side to the other and placeable in a position to limit movement of the load in a direction towards the opposite edge of the platform enabling the load to be fed to the platform either from the left or from the right.

The pallet shelf usefully has a tray-like configuration with a base, a back wall and two side walls, all preferably formed of a metal such as steel. The front of the shelf should be open to enable the pallet to be removed.

The load may be fed onto the platform from an adjacent working surface manually. Alternatively, the apparatus is adapted for use with mechanical means, such as a conveyor, for feeding a load to the platform. The means for feeding a load to the loading apparatus may be part of an article processing apparatus, such as a guillotine, a packaging apparatus, or a bag filling apparatus. The load may be selected from a stack of sheet material, such as a stack of flat or folded sheets of paper or card, one or more packages, such as finished boxes or cartons of work or postal packages, one or more flexible containers, such as sacks of particulate material e.g. building material.

The apparatus is adapted to additionally act as a pallet uploading device useful, for example, for preventing back injury when heavy loads are lifted off the floor. In this embodiment a control device is adapted to cause the following steps:
(i) to retract the platform;
(ii) to raise the pallet with a load loaded thereon from the lower position to a predetermined upper position; and
(iii) subsequently to lower the pallet from the upper position to the lower position.

The load may be unloaded from the pallet onto an adjacent working surface manually.

The platform comprises an upper support surface formed, for example, of stainless steel. The support surface has a plurality of apertures therethrough, freely rotatable members mounted in the apertures each having a surface of rotation which intersects the plane of the support surface, selected ones of the rotatable members being rotatable at least about a horizontal axis extending in an first direction and selected others of the rotatable members being rotatable at least about a horizontal axis extending in a second direction, whereby the position of the load supported on the platform may be adjusted in any horizontal direction. The first direction may be substantially at right angles to the second direction, that is within 80° to 100° thereto.

The platform may be formed with a sandwich-like structure for added strength, the rotatable members being retained between upper and lower plates. This enables the platform to have a thin construction with the benefit that the load does not drop too far when it falls onto the pallet. The upper plate of a slat has an overlapping and interlocking configuration with respect to the upper plate of each adjacent slat to add extra strength to the platform.

The rotatable members are preferably in the form of rollers formed, for example, of nylon or stainless steel. It is preferred that each roller is made of a number, say between four and ten, of independently rotatable roller parts.

The support platform may be of open frame construction, but whatever its construction, the apertures are preferably through apertures. In this way air will not become trapped within the apertures below the load, thereby further easing the movement of the load across the support platform surface.

The surface of rotation of the rotatable members preferably protrudes only just above the plane of the support surface, that is by less than 0.5 mm. This allows the load to be pushed into position on the support platform with very little resistance. In a preferred embodiment where the rotatable members are in the form of rollers, it is advantageous for these rollers to have a domed configuration, that is to have an intermediate diameter greater that the two end diameters. This allows the intermediate portion of the roller to protrude above the plane of the support surface, leaving the rollers ends level with, or even below the plane of the support surface, thereby avoiding the possibility that the load will catch on the edges of the rollers as it is moved across the support platform.

The adjacent working surface from which the load is fed onto the platform, or onto which the load is unloaded from a pallet, may be constructed in a similar manner to the platform as described above, in accordance with the second aspect of the invention.

The apparatus according to the invention is preferably constructed to be independently mobile and capable of being powered from a mains electricity supply.

The invention will now be further described, purely by way of example, with reference to the accompanying drawings, in which:

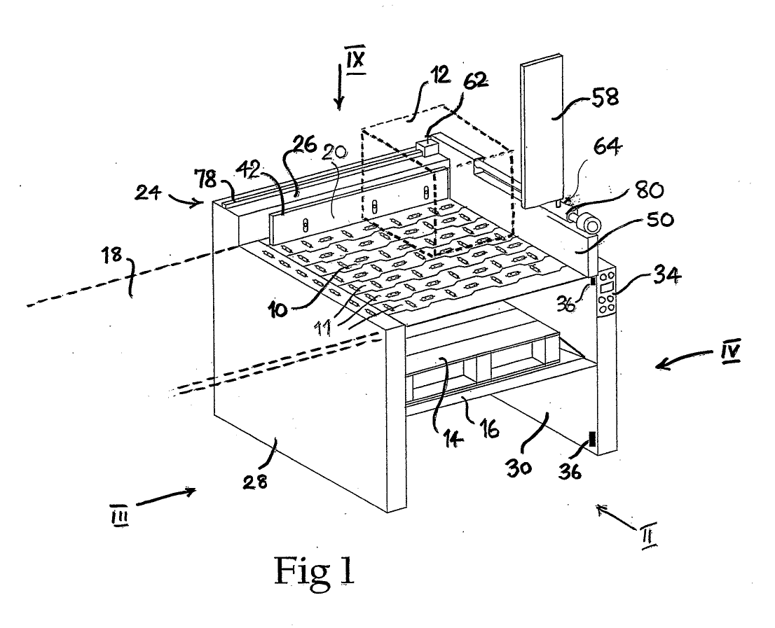

FIG. 1 shows a pallet loading apparatus according to the invention;

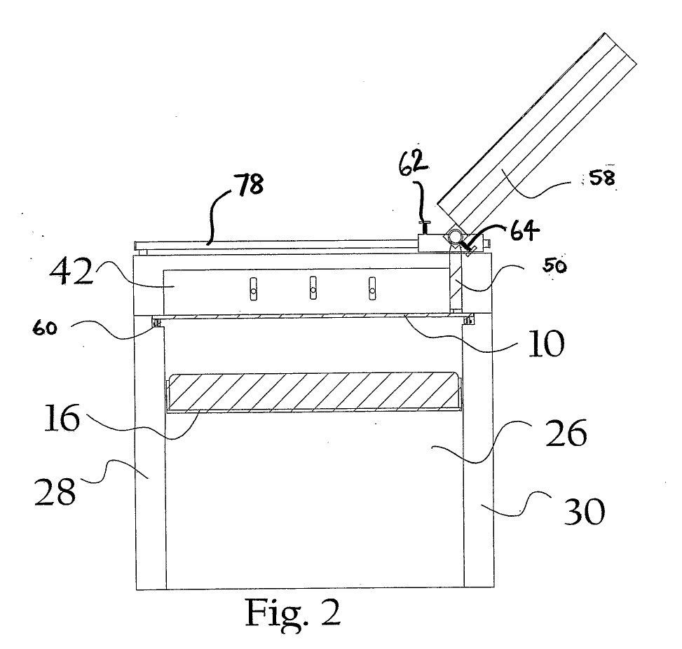

FIG. 2 is a view of the apparatus, taken in the direction II in FIG. 1;

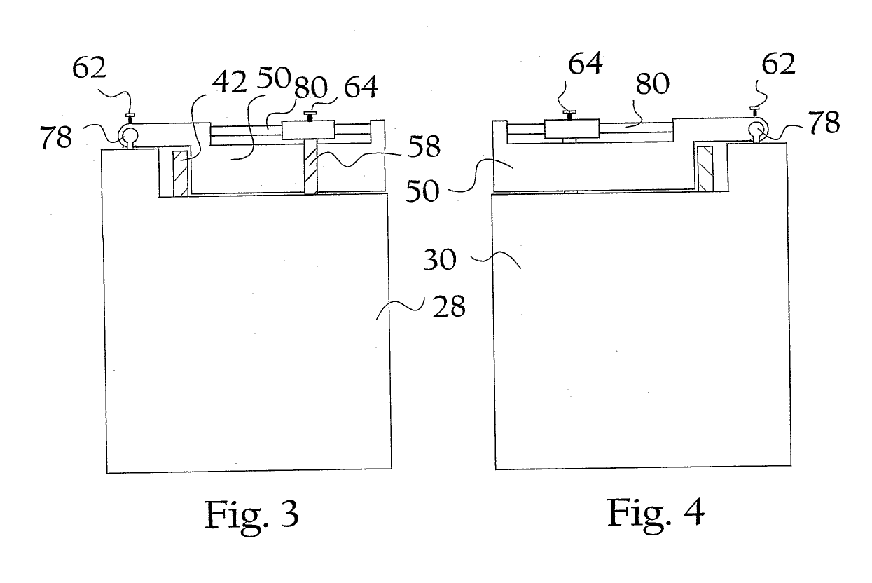

FIGS. 3 and 4 are views of the apparatus, taken in the directions III and IV respectively in FIG. 1;

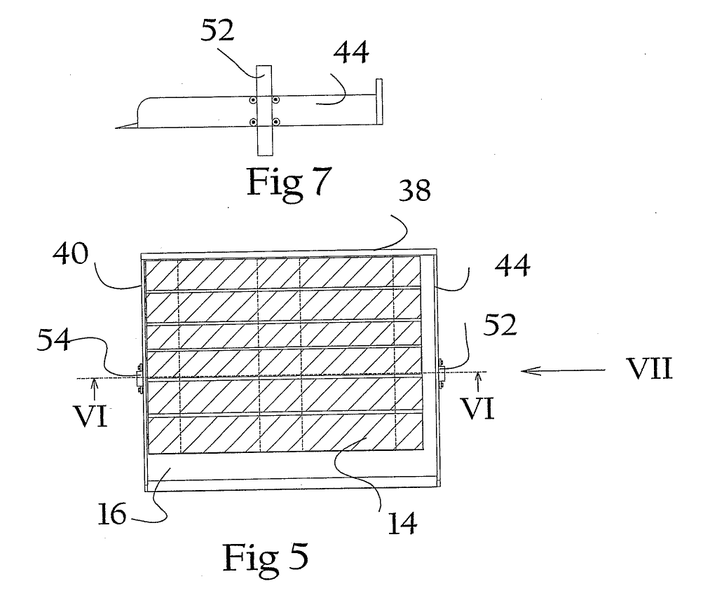

FIG. 5 shows the pallet shelf of the apparatus;

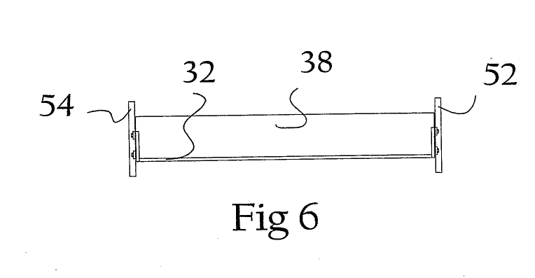

FIG. 6 is a view of the pallet shelf of the apparatus taken in the direction VI in FIG. 5;

FIG. 7 is a view of the pallet shelf of the apparatus taken in the direction VII in FIG. 5;

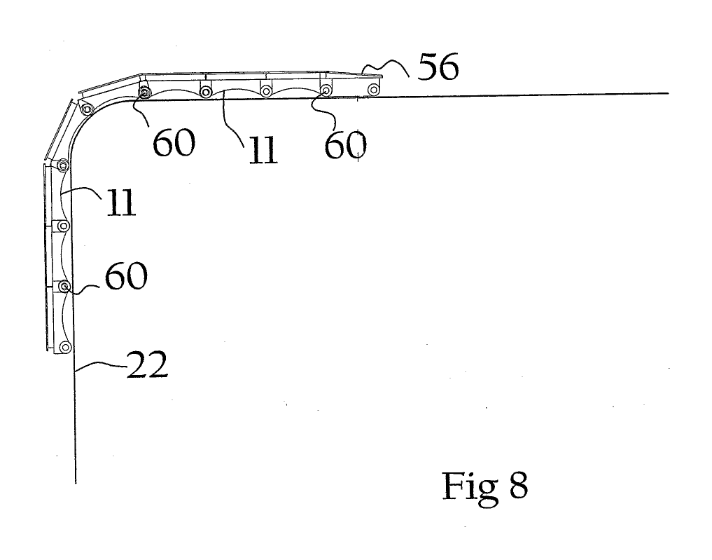

FIG. 8 is a diagrammatical representation of the loading and unloading platform of the apparatus in a partly retracted condition;

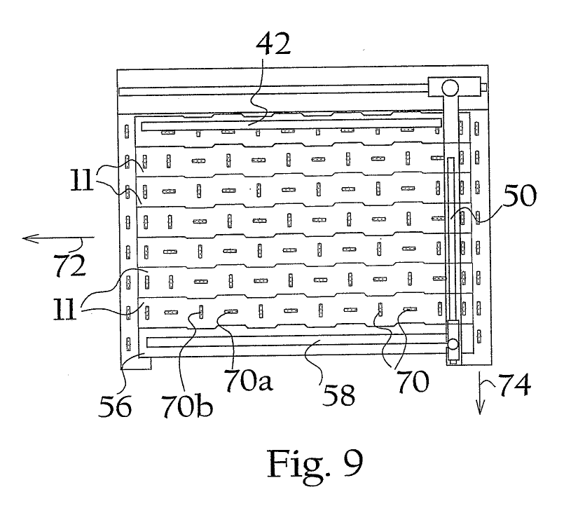

FIG. 9 is a view of the apparatus taken in the direction IX in FIG. 1;

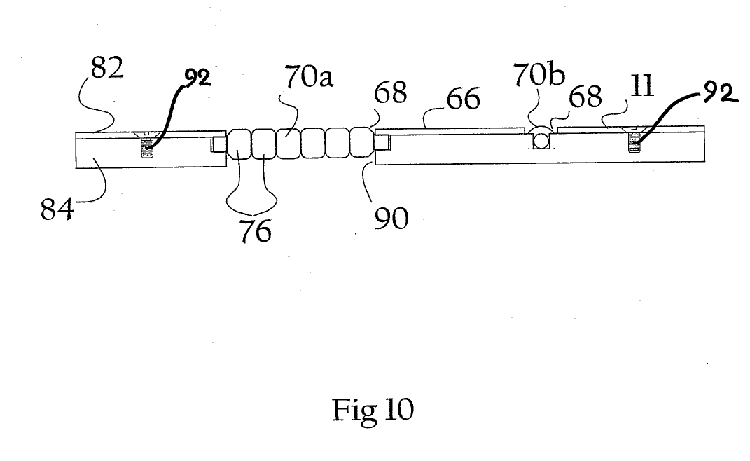

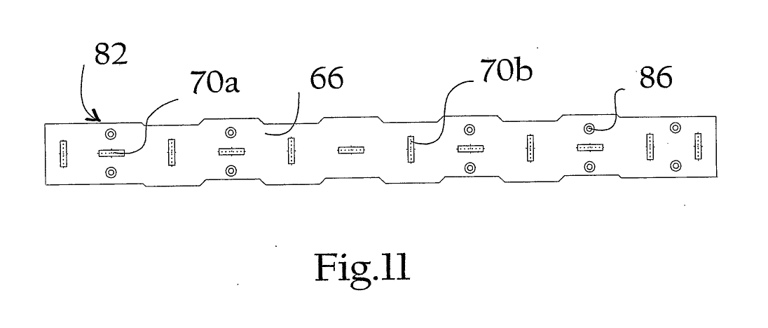

FIG. 10 is a cross sectional view of part of the platform of the apparatus;

FIG. 11 shows an upper plate of one slat of the platform of the apparatus; and

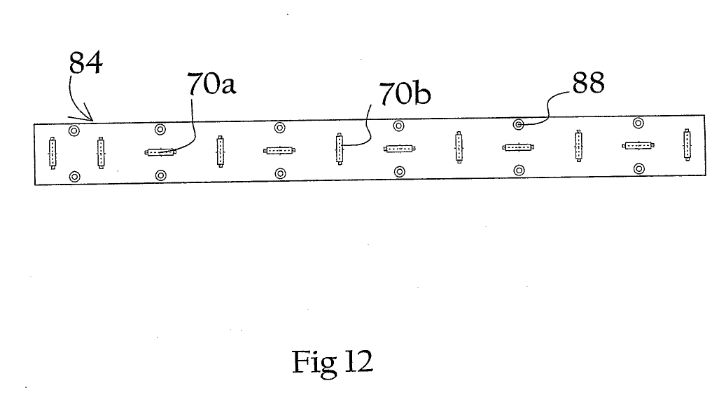

FIG. 12 shows a lower plate of the same slat.

The apparatus shown in the drawings includes a retractable articulated low-friction loading and unloading platform 10 positioned adjacent, but not necessarily attached to, a working surface 18. The apparatus is adapted to receive a stack 12 of paper sheet material (shown in broken lines only in FIG. 1) to be loaded onto a pallet 14. The articulated platform 10 is supported by an open-top housing 24 including a back wall 26 and side walls 28, 30. The articulated platform 10 is in the form of a thin sliding slatted shutter including ten articulated slats 11 constrained to move on runners 60 together along a non-linear path 22. The front slat is so shaped to form a chamfered front edge section 56.

A pallet shelf or platform 16 is provided for supporting a pallet 14 below the articulated platform 10. The pallet shelf 16 has a tray-like configuration with a base 32, a back wall 38 and two side walls 40, 44, all formed of steel. The front of the shelf is open to enable the pallet to be removed. The pallet shelf 16 is supported on two columns 52, 54 housed in the side walls 28, 30 of the apparatus to enable it to move in a vertical direction.

A chain drive device (not shown) is provided for retracting the articulated platform 10 from an extended position to a retracted position into the back wall 26. Retraction of the articulated platform 10 follows the non-linear path 22 (see FIG. 8). The return of the articulated platform 10 to its extended position follows the same non-linear path 22.

The stack 12 to be loaded onto the pallet is slid manually from the working surface 18 into position on the platform. Once the entire load for that pallet is in position, the operator activates the automatic operation of the apparatus. An abutment surface 20, provided by a back stop member 42, abuts the load 12 loaded on the articulated platform 10 as the articulated platform 10 is retracted. This causes the load 12 to drop onto a pallet supported on the pallet platform 16.

The articulated platform 10 is also provided with a side stop member 50 to limit movement of the load in a direction towards one edge of the articulated platform 10. The side stop member 50 is pivotally carried on a rail 78 which extends across the width of the housing 24, and is secured in position by a locking screw 62. By this arrangement the side stop member 50 is movable and placeable in a position to limit movement of the load in a direction towards the opposite edge of the articulated platform 10 enabling the load 12 to be fed to the articulated platform 10 either from the left or from the right.

Also, the articulated platform 10 is provided with an adjustable front stop member 58 to prevent the load from falling off the front of the platform until the latter is retracted. The front stop member 58 is pivotally carried on a rail 80 which is provided along the upper edge of the side stop member 50, and is screwed in position by a locking screw 64. By this arrangement he position of the front stop member 58 can be adjusted.

When the stop member 50 is slid from one side of the apparatus to the other to allow for loading from left to right, or from right to left, the front stop 58 is rotated 180° to perform in its new position.

The apparatus includes a chain drive device (not shown) for raising and lowering the pallet 14 supported on the pallet platform 16 between an upper position in which the load 12 can be dropped onto the pallet 14 from the articulated platform 10 and a lower position where the pallet 14, with the load 12 loaded thereon, can be removed from the apparatus.

A control device 34 is adapted to cause the following steps to take place in this order. Firstly, the articulated platform 10 is retracted when the load 12 has been received thereon, whereby the load 12 is allowed to drop onto a pallet supported on the pallet platform 16. The pallet 14 is then lowered from the upper position to the lower position. A replacement pallet is then raised from the lower position to the upper position. Finally, the articulated platform 10 is returned to its extended position before a further load 12 is received thereon.

Safety sensors 36 are provided to ensure that the pallet 14 is not raised to its upper position unless the articulated platform 10 is retracted, to ensure that the articulated platform 10 is not returned to its extended position if the load 12 remains on the pallet 14, and to prevent retraction of the articulated platform 10 when the pallet 14 is in its lower position.

A safety switch (not shown) is associated with the backstop member 42 and is adapted to ensure that if any object pushes the backstop member above the normal loading table height, the pallet shelf will stop and will not restart until the pallet is lowered and the load is re-adjusted. This enables the backstop member 42 to remain in place even when the apparatus is being used as an up-loader, as described below.

The apparatus is used for example for feeding the stack of paper 12 to the articulated platform 10 from a guillotine associated with a printing machine.

The apparatus is further adapted to act as a pallet uploading device. To this end, the control device 34 is adapted to cause the following steps. Firstly, the articulated platform 10 is retracted. The pallet 14 with a load loaded thereon is then raised from the lower position to the upper position.

As shown in FIGS. 9 and 10, the articulated platform 10 includes upper and lower plates 82, 84 having thicknesses of about 1.8 mm and 10.0 mm respectively and a plurality of apertures 68, 90 formed therethrough. The upper and lower plates are secured together in a sandwich-like arrangement by screws 92 passing through screw holes 86 and 88 respectively. The upper plate 82 has an upper support surface 66.

The upper plate 82 of a slat 11 has an overlapping and interlocking configuration with respect to the upper plate of each adjacent slat to add extra strength to the platform 10.>>D Freely rotatable roller sets 70 are mounted in the apertures 68, 90 each having a surface of rotation which intersects the plane of the support surface 66. Each roller set 70 is made up of six independently rotatable roller parts 76, each having a domed configuration. Some 70a of the roller sets are rotatable about a horizontal axis extending in an first direction 72 and others 70b of the roller sets are rotatable about a horizontal axis extending in a second direction 74, substantially at right angles to the first direction 72. The surface of rotation of the roller sets 70 protrudes above the plane of the support surface 66 by 0.2 to 0.5 mm.

By this construction of the platform, the position of the load 12 supported on the articulated platform 10 can be easily adjusted in any horizontal direction.

1. A pallet loading apparatus comprising:
(i) a loading and unloading platform (10) to receive a load (12) to be loaded onto a pallet (14);
(ii) a pallet shelf (16) for supporting a pallet (14) below the platform (10);
(iii) means for retracting the platform (10) from an extended position to a retracted position; and
(iv) an abutment surface (20) for abutting the load (12) loaded on the platform (10) as the platform (10) is retracted, whereby the load (12) is allowed to drop onto a pallet (16) supported on the pallet shelf (16);
wherein the platform (10) is in the form of a sliding shutter and retraction of the platform (10) follows a nonlinear path (22), characterised in that the platform (10) comprises an upper support surface (66) having a plurality of apertures (68) therethrough, freely rotatable members (70a, 70b) mounted in the apertures (68) each having a surface of rotation which intersects the plane of the support surface (66), selected ones (70a) of the rotatable members (70a, 70b) being rotatable at least about a horizontal axis extending in an first direction (72) and selected others (70b) of the rotatable members (70a, 70b) being rotatable at least about a horizontal axis extending in a second direction (74), whereby the position of the load (12) supported on the platform (10) may be adjusted in any horizontal direction.

2. The apparatus according to claim 1, wherein return of the platform (10) to its extended position follows the same non-linear path (22).

3. The apparatus according to claim 1, wherein the sliding shutter is a slatted shutter.

4. The apparatus according to claim 1, wherein the platform (10) is supported by a housing (24) including a back wall (26) and side walls (28, 30), the platform (10) being retractable into the back wall (26).

5. The apparatus according to claim 1, further comprising means (32) for raising and lowering a pallet (14) supported on the pallet shelf (16) between an upper position in which a load (12) can be dropped onto the pallet (14) from the platform (10) and a lower position where the pallet (14), with the load (12) loaded thereon, can be removed from the apparatus.

6. The apparatus according to claim 5 further comprising a control device (34) adapted to cause the following steps:
(i) to retract the platform (10) when the load (12) has been received thereon, whereby the load (12) is allowed to drop onto a pallet supported on the pallet shelf (16);
(ii) to lower the pallet (14) from the upper position to the lower position;
(iii) to raise a replacement pallet from the lower position to the upper position; and
(iv) to return the platform (10) to its extended position before a further load (12) is received thereon.

7. The apparatus according to claim 6, further comprising one or more safety devices (36):
(i) to ensure that the pallet (14) is not raised to its upper position unless the platform (10) is retracted; and/or
(ii) to ensure that the platform (10) is not returned to its extended position if the height of the load (12) is above the path of the platform; and/or
(iii) to ensure that the pallet shelf (16) is not lowered below a predetermined height above the floor (66), in the event of an obstruction being detected below the pallet shelf.

8. The apparatus according to claim 1, wherein the abutment surface (20) is provided by a back stop member (42).

9. The apparatus according to claim 1, wherein the platform (10) is provided with side stop members (50) to limit movement of the load in a direction towards one edge of the platform (10).

10. The apparatus according to claim 9, wherein the side stop members (50) are movable and placeable in a position to limit movement of the load in a direction towards the opposite edge of the platform (10).

11. The apparatus according to claim 1, being part of an article processing apparatus.

12. The apparatus according to claim 11, wherein the article processing apparatus is selected from a guillotine, a packaging apparatus, and a bag filling apparatus.

13. The apparatus according to claim 12, wherein the load (12) is selected from a stack of sheet material, one or more packages, and one or more flexible containers.

14. The apparatus according to claim 1, further comprising a control device (34) adapted to cause the following steps:
(i) to retract the platform (10);
(ii) to raise the pallet (14) with the load (12) loaded thereon from the lower position to the upper position, and
(iii) subsequently to lower the pallet (14) from the upper position to the lower position.

15. The apparatus according to claim 1, wherein the rotatable members (70a, 70b) are in the form of rollers.

16. The apparatus according to claim 15, wherein the rollers (70a, 70b) have a domed configuration.

17. The apparatus according to claim 1, wherein the first direction (72) is substantially at right angles to the second direction (74).

18. The apparatus according to claim 1, wherein the surface of rotation of the rotatable members (70a, 70b) protrudes above the plane of the support surface (66) by less than 0.5 mm.
